(19) United States
(12) Patent Application Publication
(10) Pub. No.: US 2025/0276935 A1
(43) Pub. Date: Sep. 4, 2025

(54) GLASS STACKING, PREPARATION PROCESS THEREOF AND WINDOW ASSEMBLY COMPRISING THE GLASS STACKING

(71) Applicant: SAINT-GOBAIN GLASS FRANCE, COURBEVOIE (FR)

(72) Inventors: Daming LI, SHANGHAI (CN); Jianfeng ZHANG, SHANGHAI (CN)

(21) Appl. No.: 18/859,421

(22) PCT Filed: Jun. 26, 2023
(86) PCT No.: PCT/CN2023/102278

§ 371 Date: Oct. 23, 2024

(30) Foreign Application Priority Data
Jun. 28, 2022 (CN) 202210750187.1

(51) Int. Cl. C03C 17/34

(52) U.S. Cl. CPC C03C 17/3417; C03C 2217/211; C03C 2217/228; C03C 2217/478; C03C 2218/11; C03C 2218/152

(57) ABSTRACT

A glass stacking includes a glass substrate; a low-emissivity layer; and an overcoat layer; wherein the low-emissivity layer is between the glass substrate and the overcoat layer; the low-emissivity layer is formed by chemical vapor deposition; the overcoat layer is formed by a coating layer containing a wet coating, and the wet coating includes a silica sol and/or a water glass solution.

### TECHNICAL FIELD

The present disclosure relates to the technical field of glass, in particular to a glass stacking, a preparation process thereof and a window assembly comprising the glass stacking.

### BACKGROUND

A low-emissivity (low-E) glass has the advantages of transmitting visible light and reflecting infrared rays, which can reduce energy consumption and improve user comfort. It shows the benefit of being green and environmental friendly and there is a huge market demand.

It is a conventional means to provide a low emissivity film on a glass substrate to obtain a low emissivity glass. CN103073196A discloses a silver-based low-emissivity coated glass, which includes a glass substrate and a low-emissivity film. By adding a high refractive index layer and a low refractive index layer, on the one hand, it can better block the diffusion of alkali metal ions in glass during high-temperature heat treatment; and on the other hand, it can greatly improve the reflectivity of near-infrared region under the condition where the visible light transmittance is basically unchanged, whereby reducing the direct solar energy transmittance and having better solar energy barrier ability.

In addition, a low-emissivity glass can be prepared by providing a low-emissivity layer on the glass surface by chemical vapor deposition (CVD). The preparation process has low cost and good market applicability.

However, the surface of the coating formed by CVD usually has a columnar structure (as shown in FIG. 1), resulting in high surface roughness, making the glass structure difficult for cleaning, and also producing a series of defects such as high diffuse reflection, high haze and high visible light reflectivity.

In the prior art, an anti-reflection coating may also be prepared on a glass substrate by magnetron sputtering technology, and the obtained low-emissivity glass product has a smooth surface and the advantages of low haze and low reflection. However, such a preparation process is not cost-effective and not conducive for market application.

### SUMMARY

In order to solve a series of problems in this field, such as high surface roughness, poor optical performance of a low-emissivity glass prepared by chemical vapor deposition and high preparation cost of magnetron sputtering technology, provided is a glass stacking, in which a low-emissivity layer obtained by chemical vapor deposition is on the surface of a glass substrate and an overcoat layer obtained by wet coating method is on the surface of the low-emissivity layer. The provided glass stacking has the advantages of low haze, low visible light reflectivity, bendability, easy for cleaning, good durability, low preparation cost and so forth, and is promising in market application.

In one aspect, provided is a glass stacking comprising: a glass substrate, a low-emissivity layer and an overcoat layer, wherein the low-emissivity layer is between the glass substrate and the overcoat layer, the low-emissivity layer is formed by chemical vapor deposition, the overcoat layer is formed by a coating layer containing a wet coating, and the wet coating comprises a silica sol and/or water glass silicate.

In an embodiment, the particle sizes of silica colloidal particles in the silica sol are 30 nm or less.

In another embodiment, the water glass solution comprises any one of a sodium water glass, a lithium water glass and a potassium water glass or any combination thereof.

In another aspect, provided is a process for preparing the glass stacking according to the present disclosure, comprising the following steps: providing a glass substrate having a low-emissivity layer formed by chemical vapor deposition thereon, or providing a glass substrate and forming a low-emissivity layer by chemical vapor deposition on the glass substrate; applying a wet coating on the low-emissivity layer to form a coating containing the wet coating on the surface of the low-emissivity layer; drying the coating layer containing the wet coating, and curing the coating layer.

In yet another aspect, provided is a window assembly comprising the glass stacking according to the present disclosure.

### BRIEF DESCRIPTION OF THE DRAWINGS

FIG. 1 shows a cross-sectional diagram of the glass with a low-emissivity layer obtained by chemical vapor deposition, where a columnar structure of the low emissivity layer is shown.

FIG. 2 shows a schematic diagram of an embodiment of the glass stacking according to the present disclosure.

FIG. 3 shows a cross-sectional diagram of an embodiment of the glass stacking according to the present disclosure, wherein the overcoat layer is formed by wet coating method with silica sol.

FIG. 4 shows a single mode bending test of the glass stacking.

### DETAILED DESCRIPTION

### General Definition and Terms

Unless otherwise stated, all publications, patent applications, patents and other references mentioned herein are incorporated by reference in their entirety.

Unless otherwise defined, the technical and scientific terms used herein have the same meaning as commonly understood by a person skilled in the art. If there is a contradiction, the definition provided in this application shall prevail.

Unless otherwise stated, all percentages, parts, proportions or the like are on a weight basis. When an amount, concentration or other value or parameter is given as a range, a preferable ranges or a preferable upper limit and lower limit or a specific value, it should be understood that it corresponds to specifically revealing any range by combining any pair of upper limit of the range or preferable range value with the lower limit of any range or preferable range value, regardless of whether the range is specifically disclosed. Unless otherwise stated, the numerical ranges listed herein are intended to include the endpoints of the range and all integers and fractions within the range.

When used with a numerical variable, the term “about” or “approximate” usually refers to the value of the variable and all the values of the variable within the experimental error (for example, within an average 95% confidence interval) or within ±10% of the specified value, or a wider range.

The term “optional” or “optionally” means the event described subsequent thereto may or may not happen. This term encompasses the cases that the event may or may not happen, and that the contents are selected in an arbitrary manner.

The terms “include”, “comprise”, “have”, “contain” or “involve” and other variants thereof herein are meant to be inclusive or open-ended, which do not exclude other unlisted elements or process steps. It should be understood by those skilled in the art that the above terms such as “include” encompass the meaning of “consisting of”. The expression “consisting of” excludes any element, step, or ingredient not designated. The expression “substantially consisting of” means that the scope is limited to the designated elements, steps or ingredients, plus elements, steps or ingredients that are optionally present which do not substantially affect the essential and novel feature of the claimed subject matter. It should be understood that the expression “comprise” encompasses the expressions “substantially consist of” and “consist of”. The term “selected from” refers to one or more elements of the group listed thereafter, selected independently, and may encompass the combination of two or more elements.

The term “one or more” or “at least one” as used herein means one, two, three, four, five, six, seven, eight, nine or more.

The term “and/or” as used herein encompasses both “and” and “or”. A plurality of elements, components or steps defined by “and/or” means any one of the elements, components or steps and any combination thereof. For example, A and/or B encompasses A, B and A+B; A, B and/or C encompasses A, B, C, A+B, A+C, B+C and A+B+C.

Unless otherwise stated, the terms “combination thereof”, “any combination thereof” and “mixture thereof” mean multicomponent mixtures of the elements, such as two, three, four and up to the maximum possible multicomponent mixtures.

In addition, if the number of parts or components of the disclosure is not indicated before, it means that there is no limit to the number of parts or components. Therefore, it should be interpreted as including one or at least one, and the singular word form of a part or component also includes the plural, unless the numerical value clearly indicates the singular.

Unless otherwise stated, the expressions “first”, “second” and so forth as used herein are only used to distinguish various elements, components or steps without limiting the sequence and the number, or excluding the existence of more elements, components, or steps that are not listed, such as “third” and “fourth”. Elements, components or steps defined as “first” and “second” can be the same or different.

As used herein, the meanings of “a plurality” and “multiple layers” refer to two or more, unless otherwise specifically defined. Unless the context clearly indicates, “a” and “an” can encompass singular reference as well as plural reference.

Unless otherwise specifically defined, the terms such as “installation”, “connection” and “attach” as used herein should be understood in a broad means. For example, it can be fixed connection, detachable connection or integrated; it can be directly connected or indirectly connected through an intermediate medium, and it can be the internal communication of two elements or the interaction between two elements. For those skilled in the art, the specific meanings of the above terms herein can be understood according to the specific situation.

### The Glass Stacking of the Disclosure

In one aspect, provided is a glass stacking comprising: a glass substrate, a low-emissivity layer and an overcoat layer. The low-emissivity layer is between the glass substrate and the overcoat layer, which is a low-emissivity layer formed by chemical vapor deposition. The overcoat layer is formed by a coating layer containing a silica sol and/or a water glass solution.

### Glass Substrate

Glass substrate is an amorphous inorganic nonmetallic material, which is generally made of a variety of inorganic minerals (such as quartz sand, borax, boric acid, barite, barium carbonate, limestone, feldspar, soda ash, etc.) as the main raw materials and a small amount of auxiliary raw materials. Its main components are silicon dioxide and other oxides. “Glass” may be any type of glass, for example ordinary glass, whose chemical composition comprises Na₂SiO₃, CaSiO₃, SiO₂ or Na₂O.CaO.6SiO₂, etc., such as silicate double salt, which is an amorphous solid with irregular structure. For example, glass can be colorless glass and it can also be colored glass into which certain metals oxides or salts are mixed to exhibit colors, or tempered glass obtained by a physical or chemical method and so forth. In addition, the structure of “glass” itself is not particularly limited, and it can be single-layer glass or multi-layer glass, or other types of glass, such as insulating glass and so forth.

In a specific embodiment, the glass substrate is a glass pane. The shape of the glass substrate can be arbitrary. According to the actual needs, examples of glass substrates are square, rectangular, round, oval, regular hexagon and so forth. As used herein, according to the actual needs, the surface of the glass pane can be horizontal and flat, or with a radian, or with an irregular radian.

### Low-Emissivity Layer

As used herein, the low-emissivity (Low-e) layer refers to the coating applied on the surface of the glass substrate, which has a low radiation coefficient. The far-infrared reflection performance of the glass can be effectively reduced by covering the low-emissivity layer on the surface of the glass substrate and it can provide a better user experience for users.

The term “emissivity” is understood as a standard emissivity at 283K according to the standard EN12898. Generally, the thickness of the low-emissivity layer can be adjusted according to the type of the layer to obtain the required emissivity, which may depend on the desired thermal performance. The emissivity of the low-emissivity layer can be, for example, about 0.5 or less, especially about 0.3 or less or even about 0.2 or less. Emissivity 1 is equivalent to the emissivity of an ideal black body (which can absorb all radiant energy). The low-emissivity layer usually contains a metal or metal oxide layer, and it may also contain a dopant material such as fluorine, tin, indium or antimony as needed.

The low-emissivity layer can be obtained by chemical vapor deposition. Chemical vapor deposition utilizes one or more vapor compounds or elementary substances containing the elements to be deposited to carry out a chemical reaction on the surface of a glass substrate, thereby generating a low-emissivity film (layer), that is, a low-emissivity layer. In present disclosure, the elements to be deposited include, but are not limited to, fluorine (F), tin (Sn), indium (In), antimony (Sb), etc. In an embodiment, the low-emissivity layer contains one or more components selected from, but not limited to, tin oxyfluoride (F—SnO₂), indium tin oxide (In—SnO₂), antimony tin oxide (Sb—SnO₂), etc.

In an embodiment, the glass substrate with a low-emissivity layer may comprise any one of the following: ITO (Indium Tin Oxide) glass, FTO (Fluorine-doped Tin Oxide) glass, and ATO (Antimony-doped Tin Oxide) glass. ITO glass, FTO glass and ATO glass can also be used in any combination. ITO glass refers to a glass substrate with indium tin oxide doped layer; FTO glass refers to a glass substrate with a tin oxyfluoride doped layer; ATO glass refers to a glass substrate with antimony tin oxide doped layer. In a specific embodiment, the glass substrate with a low-emissivity layer is a combination of FTO glass and ATO glass, that is, a glass substrate with both a doped layer of tin oxyfluoride and a doped layer of antimony tin oxide, such as AGC grey LowE glass.

Generally, the low-emissivity layer with a certain thickness will improve the optical performance of the glass substrate. For example, the low-emissivity layer typically has a thickness of tens to hundreds of nanometers. As an example, for a layer made of ITO, the layer typically has a thickness of at least about 40 nm, even at least about 50 nm, or even at least about 70 nm, and typically at most about 150 nm or at most about 200 nm. For a layer made of fluorine-doped tin oxide, the layer typically has a thickness of at least about 120 nm, even at least about 200 nm, and typically at most about 500 nm. The shape of the low-emissivity layer is not particularly limited, and it may cover all or part of the surface of the glass substrate to improve the optical performance of the glass in the target area.

### Overcoat Layer

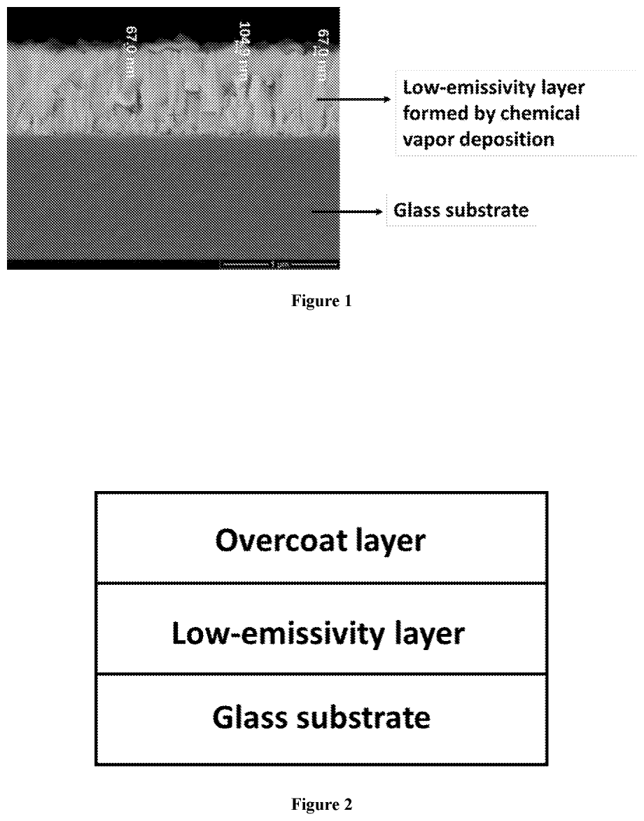

As the surface of the coating formed by the chemical vapor deposition process usually has a columnar structure (as shown in FIG. 1), its surface roughness is likely to be high. The high surface roughness makes the glass product difficult for cleaning, and also causes a series of defects such as high diffuse reflection, high haze and high visible light reflectivity.

In the present disclosure, an overcoat layer can be further provided on the surface of the low-emissivity layer through wet coating method. The existence of the overcoat layer can protect the structure of the low-emissivity layer, avoid the performance degradation caused by wear, and provide a surface with low roughness to avoid the adverse effects caused by the roughness of the columnar structure in the low-emissivity layer, and thus obtaining a glass stacking with low haze, low visible light reflectivity, bendable and easy for cleaning. As needed, the overcoat layer can be oriented in the desired direction, such as the interior or exterior of a building or vehicle.

In an embodiment, the wet coating method in the present disclosure may comprise the following: for glass substrate with a low-emissivity layer, applying a wet coating on the surface of the low-emissivity layer to form a coating layer containing the wet coating; subsequently, the volatile phase (such as solvent) contained in the coating layer containing the wet coating is volatilized through the drying process while the non-volatilized substances in the wet coating uniformly cover the surface of the low-emissivity layer, which will fully fill the uneven positions (such as microscopic depression sites) on the surface of the low-emissivity layer. The non-volatilized substances can be cured as required through subsequent curing processes (such as photocuring, heat curing, etc.) and form a stable and strong bond with the low-emissivity layer, in order to form a flat and smooth overcoat layer.

The advantages of forming the overcoat layer by wet coating method comprise, but are not limited to the following: 1. convenient operation and low cost; 2. being flexibly adapted to different substrate shapes to meet different application requirements; 3. the wet coating can be selected flexibly according to the actual needs and has a good material compatibility; 4. before or during the curing process, the glass stacking can be flexibly adjusted (such as performing hot bending operation) so as to obtain glass stacking products with different structures.

A wet coating usually contains a volatile phase (such as solvent) and a non-volatile phase (such as solute). The non-volatile phase is uniformly dispersed in the volatile phase and form a wet coating with suitable hydrodynamic properties (such as viscosity), so as to form a uniform coating layer containing the wet coating on the coated surface. The hydrodynamic properties of the wet coating can be adjusted by selecting different volatile phases. The volatile phase of the wet coating is volatilized during drying process. In an embodiment, the solvent of the wet coating may comprise water, alcohol, or a water-alcohol mixture. Examples of alcohols comprise, but are not limited to, alcohols having 1-6 carbon atoms. In the present disclosure, when the solvent used comprises ethanol and/or isopropanol, the levelling property of the coating will be better, and a flatter and more uniform coating can be formed, enabling an overcoat layer with flat surface and uniform thickness to be obtained. In a specific embodiment, the solvent of the wet coating is a combination of water, ethanol and isopropanol. Non-volatile phase may be retained on the surface of glass stacking, and it may be directly retained or undergo corresponding chemical reactions through subsequent processes to form an overcoat layer. The overcoat layer usually has good high temperature resistance and good compatibility with the glass stacking.

A wet coating may also comprise other suitable additives to improve the viscosity, stability, optical performance and so forth.

In an embodiment, the wet coating comprises a silica sol. Silica sol usually contains silica colloidal particles and a solvent. Solvents may be used for dispersing silica colloidal particles to form a silica sol. The solvent of silica sol may comprise water, alcohol or water-alcohol mixture, such as a mixed solvent formed by water, ethanol and isopropanol. Silica colloidal particles are colloidal particles with certain sizes (usually nanometer level), which are dispersed by solvents. The particle sizes of silica colloidal particles may be about 30 nm or less, for example, about 25 nm or less, about 20 nm or less, and preferably about 20 nm or less. Colloidal silica particles with appropriate particle size are useful to reduce the roughness of the surface of the low-emissivity layer, and then form a smooth and compact overcoat layer, which may further improve the performance of the glass stacking. Silica sol can be deposited on the low-emissivity layer by a sol-gel method. Through the drying and curing process, a compact and smooth silicon dioxide layer (i.e., overcoat layer) will be formed on the surface of the low-emissivity layer.

Commercially available silica sol can be used as the wet coating. For example, silica sol with the following parameters: the particle sizes of silica colloidal particles being about 8-16 nm, the solid content of silica colloidal particles being about 20%-30%, the solvent being water, and being deposited on the low-emissivity layer by sol-gel method. Silica sol can also be prepared by conventional methods in this field, such as by using a precursor capable of reacting to generate a silica sol, which are reacted accordingly (e.g., hydrolysis) under acidic condition (addition of a suitable acid, e.g., hydrochloric acid) to obtain a silica sol. Useful precursors may comprise, but are not limited to, tetramethyl orthosilicate, tetraethyl orthosilicate, methyltriethoxysilane (MTEOS), etc. In a specific embodiment, the silica sol is prepared by the hydrolysis of tetraethyl orthosilicate under the catalysis of acidic condition. In the obtained silica sol, the particle sizes of silica colloidal particles are less than about 10 nm, the solid content of silica colloidal particles is about 3%-20%, and the solvent is a mixed solvent of water-ethanol/isopropanol. In an embodiment, silica sol can be deposited on the low-emissivity layer by sol-gel method after completing the process of preparing the silica sol.

In another embodiment, the wet coating comprises a water glass solution. The water glass solution comprises any one of the following: a sodium water glass (Na₂O.nSiO₂) solution, a lithium water glass (Li₂O.nSiO₂) solution and a potassium water glass (K₂O.nSiO₂) solution. A combination of these water glass solutions may also be used. The use of sodium water glass or potassium water glass is preferred as it can reduce the cost. The “n” is the modulus of water glass, which is the molecular ratio of silicon oxide to alkali metal oxide in water glass. In an embodiment, the water glass may have a water glass modulus of 2-4 in order to obtain a compact overcoat layer with a suitable refractive index. A coating containing a water glass solution is formed by applying the water glass solution on the surface of the low-emissivity layer, and then a compact and smooth silicate coating (i.e., an overcoat layer) is formed on the surface of the low-emissivity layer through subsequent drying and curing processes.

In an embodiment, the overcoat layer has a thickness of about 90 nm-120 nm, for example, about 90 nm-100 nm, about 90 nm-110 nm, about 95 nm-100 nm, about 95 nm-110 nm, about 95 nm-120 nm, about 100 nm-110 nm, about 100 nm-120 nm, etc., or such as about 90 nm, about 90.3 nm, about 92 nm, about 95 nm, about 98 nm, about 100 nm, about 102 nm, about 105 nm, about 107 nm, about 110 nm, about 115 nm, about 117 nm, about 120 nm, etc. The suitable thickness of the cover layer may improve the performance (such as optical performance, mechanical performance, etc.) of glass stacking. The overcoat layer with suitable thickness may fully fill the uneven sites (such as microscopic depression) of the low-emissivity layer, and the overcoat layer itself forms a smooth surface, thus fully reducing the roughness of the surface of the low-emissivity layer and avoiding the adverse effects caused by roughness. The suitable thickness of the overcoat layer can also reduce the light reflection, especially the visible light reflection.

The shape of the overcoat layer is not particularly limited, and it can completely cover the surface of the low-emissivity layer or only cover part of the surface of the low-emissivity layer according to actual needs. In an embodiment, the overcoat layer completely covers the low-emissivity layer.

### Glass Stacking

The glass stacking of the present disclosure comprises a glass substrate, a low-emissivity layer and an overcoat layer as described herein. The low-emissivity layer is between the glass substrate and the overcoat layer.

In an embodiment, such as that shown in FIG. 2, one side of the glass substrate is covered with a low-emissivity layer and the other side of the low-emissivity layer away from the glass substrate is covered with an overcoat layer.

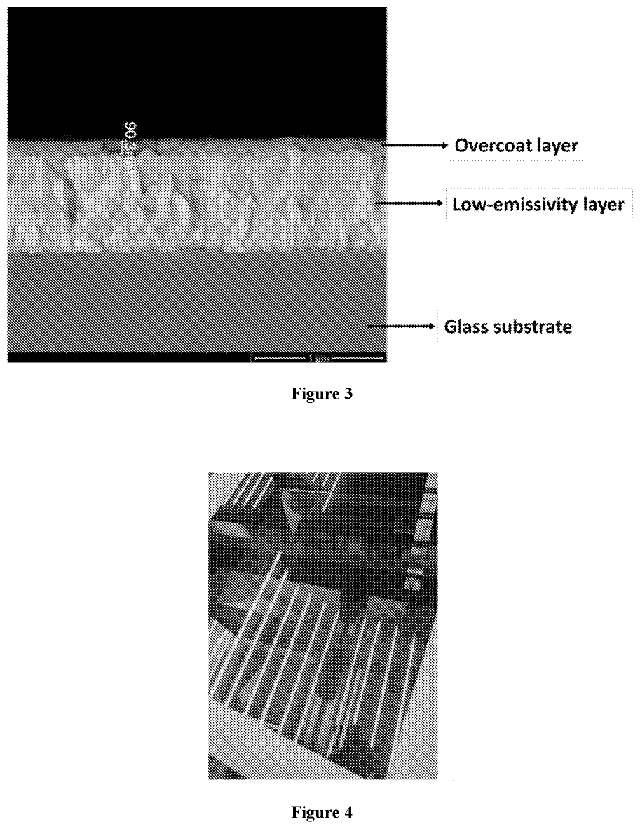

In a specific embodiment, the glass substrate with low-emissivity layer is AGC grey LowE glass and the surface of the low-emissivity layer is covered with an overcoat layer formed by wet coating method with silica sol. The overcoat layer has a thickness of 90.3 nm (as shown in FIG. 3).

### Performance and Test

The glass stacking of the disclosure has excellent performance.

Visible light reflectivity: the percentage of light intensity reflected by glass stacking to incident light intensity in the visible spectrum range. It can be measured by conventional methods and instruments, for example, measured by instrument of Perkin-Elmer Lambda 950 and by standard ISO9050. In an embodiment, the glass stacking of the present disclosure has a visible light reflectivity of about 2% or less, such as about 1.54%.

Haze: the percentage of transmitted light intensity that deviates from the incident light by an angle of more than 2.5° to the total transmitted light intensity. A higher haze means a reduction in the gloss and transparency of glass stacking. It can be measured by conventional methods and instruments, for example, measured by instrument of BYK Haze-guard plus and by standard ASTM D1003 and D1044. In an embodiment, the glass stacking of the present disclosure has a haze of about 2% or less, such as about 1.78%.

Easy for cleaning: due to the smooth and compact overcoat layer covered on the glass stacking, it is less prone to be contaminated and easy for cleaning, which may reduce the maintenance cost in use.

Durability: the presence of a smooth and compact overcoat layer helps to avoid the wear of low-emissivity layer and improves the durability of glass stacking.

Bending performance: the glass stacking of the disclosure has good bending performance. The bending performance can be measured by conventional methods and instruments, for example, single mode bending test (as shown in FIG. 4). The glass stacking of the disclosure can pass the single mode bending test and it can be bent without forming any crack.

### Preparation Process

In another aspect, provided is a process for preparing a glass stacking, comprising the following steps:
providing a glass substrate having a low-emissivity layer formed by chemical vapor deposition thereon, or providing a glass substrate and forming a low-emissivity layer by chemical vapor deposition on the glass substrate; applying a wet coating on the low-emissivity layer to form a coating layer containing the wet coating on the surface of the low-emissivity layer; drying the coating layer containing the wet coating.

The individual operations and processes in the process for preparing the glass stacking can be carried out in a conventional way in the field.

As for the provided glass substrate, there may be a low-emissivity layer formed by chemical vapor deposition thereon, i.e., a glass substrate with a low-emissivity layer. A commercially available glass substrate with a low-emissivity layer formed by vapor deposition may be used. It is also possible to provide a glass substrate and prepare a low-emissivity layer on the glass substrate by chemical vapor deposition to obtain a glass substrate with a low-emissivity layer.

The surface of the low-emissivity layer can be cleaned as required prior to applying the wet coating, thus facilitating the uniform application of the wet coating and at the same time increasing the bonding force between the subsequently formed overcoat layer and the low-emissivity layer. The stability of the glass stacking may also be increased. In an embodiment, a manner of applying the wet coating comprises slot die, for example, sheet by sheet slot die, which can increase the coating efficiency and improve the coating effect. The coating equipment can be selected from conventional equipment, for example a coating machine.

Drying the coating containing a wet coating allows the volatile substances (such as solvents) in the coating layer containing a wet coating to volatilize and the non-volatilized substances in the wet coating uniformly cover the surface of the low-emissivity layer.

The drying treatment can be carried out by conventional methods and equipment, for example but not limited to oven drying, microwave drying, infrared drying, etc. The purpose of drying treatment is to volatilize the volatile substances comprised in the coating layer containing the wet coating. The selection of a suitable drying time period and temperature helps the volatilization process to proceed fully and smoothly and avoids unevenness of the surface due to violent volatilization. The drying time period may be about 1-10 min, for example, about 3 min. The drying temperature may be about 80° C.-150° C. In an embodiment, drying treatment is performed at about 80° C.-150° C. for about 3 min.

After the drying step, the coating will be cured. The curing process can be reasonably selected according to the properties of the wet coating. In an embodiment, the curing process uses heat treatment for curing. In an embodiment, the curing process adopts photocuring or other curing methods. These curing processes can be used in combination with heat treatment, for example, curing after heat treatment. By curing the overcoat layer (e.g. by heat curing), the overcoat layer can be formed which is stably bonded to the low-emissivity layer. The heat treatment process can be carried out by conventional equipment, and the temperature and time of heat treatment will affect the curing process, bending and tempering. The temperature of the heat treatment may be about 550° C.-750° C., for example, about 650° C. The time for the heat treatment can be about 1-30 min, e.g. about 5 min. In an embodiment, the heat treatment lasts for about 5 min at about 650° C. In addition, heat treatment enables processes such as bending and tempering of glass, thereby improving the mechanical properties and so forth of the glass stacking.

In another aspect, provided is also a window assembly, comprising the glass stacking described herein.

In an embodiment, the window assembly comprises a door, a window, a curtain wall, a vehicle window glass, an airplane glass or a ship glass.

It should be understood that the embodiments shown in the figures herein only show the optional architecture, shape, size and arrangement of various optional components in the glass stacking and the window assembly according to the present disclosure, however, they are merely illustrative and not restrictive, and other shape, size and arrangement may be adopted without departing from the spirit and scope of the present disclosure.

### Beneficial Effects

Through wet coating method, the present disclosure can eliminate the adverse effects caused by the roughness of the low-emissivity layer deposited by chemical vapor deposition, and form a low-emissivity glass stacking with a compact and smooth overcoat layer, which has the advantages of low haze, low visible light reflectivity, bendable, easy for cleaning, good durability and so forth, The present glass stacking has a low preparation cost and is promising in market application.

### EXAMPLES

The following provides a further detailed description of the scheme of the present disclosure in conjunction with specific examples.

It should be noted that the following examples are only examples for clearly explaining the technical scheme of the present disclosure, and are not limitations of the present disclosure. For an ordinary technical person in the art, other changes or modifications in different forms can be made on the basis of the above description, and it is unnecessary and impossible to exhaust all the embodiments herein and the obvious changes or modifications derived therefrom are still within the protection scope of the present disclosure. Unless otherwise specified, the instruments, equipment and reagent materials used herein are commercially available.

### Materials, Instruments and Test Methods

Glass substrate with low-emissivity layer: AGC grey LowE glass, purchased from Aijiexu Special Glass (Dalian) Co., Ltd.

### Wet Coating

Wet coating 1: silica sol with the preparation process of being formed by hydrolyzing the tetraethyl orthosilicate under the catalysis of acidic condition. The sizes of particles in the sol are <10 nm and the solid content is 3%-20%. The solvent is a mixed solvent of water, ethanol and isopropanol. All raw materials are analytically pure grade and purchased from Sinopharm Group.
Wet coating 2: silica sol, with the sizes of particles in the sol of 8-16 nm and a solid content of 20%-30%. The solvent is water. It is purchased from Qingdao FUSO Precision Processing Co., Ltd. with the trade name of DS-13.
Wet coating 3: potassium sodium silicate with a modulus of 2-4, purchased from Xingtai Dayang Co., Ltd. with the trade name of DY-4.0.
   Haze: the equipment of BYK Haze-guard plus is used and the equipment standards are ASTM D1003 and D1044.
   Visible light reflectivity: the equipment is Perkin-Elmer Lambda950, test standard: ISO9050.

### Preparation and Performance

Example 1: The glass stacking of Example 1 was prepared according to the following process, in which the glass substrate with low-emissivity layer was AGC grey LowE and the overcoat layer was formed by wet coating 1:

On the surface of low-emissivity layer of AGC grey LowE glass, wet coating 1 was applied by slot die via a coating machine, dried at 80° C.-150° C. for 3 min and then heat treated at 650° C. for 5 min.

Example 2: the glass stacking of Example 2 was prepared with reference to the process of Example 1, in which the glass substrate with low-emissivity layer was AGC grey LowE and the overcoat layer was formed by wet coating 2.

Example 3: the glass stacking of Example 3 was prepared with reference to the process of Example 1, in which the glass substrate with low-emissivity layer was AGC grey LowE and the overcoat layer was formed by wet coating 3.

Example 4: the glass stacking of Example 4 was prepared with reference to the process of Example 1, in which the glass substrate with low-emissivity layer was AGC grey LowE and the overcoat layer was formed by wet coating 1. The cross section of the obtained glass stacking is shown in FIG. 3, in which the overcoat layer has a thickness of 90.3 nm.

Comparative Example 1: a glass substrate with low-emissivity layer (AGC grey LowE) without overcoat layer on the surface.

The results of performance test of Example 1 and Comparative Example 1 are shown in Table 1 below:

TABLE 1

| | Visible light | | | | |
|---|---|---|---|---|---|
| | reflectivity (%) | Haze (%) | L* | a* | b* |
| Example 1 | 1.54 | 1.78 | 13.89 | 4.92 | −21.80 |
| Comparative | 6.50 | 4.51 | 30.74 | −5.86 | −2.59 |
| Example 1 | | | | | |

L*, a* and b* are the coordinates of CIE1976 uniform color space, representing black and white, red and green, yellow and blue respectively.

According to the table above, compared with Comparative Example 1, Example 1 having the overcoat layer showed a significantly reduced the visible light reflectivity and haze and had a good optical performance.

Further, the single mode bending test was carried out on Example 1, and the results of single-piece mold hot bending test are shown in FIG. 4. The glass stacking of Example 1 showed good bendable properties and did not form any cracks.

Examples 2 and 3 also had good optical performance, with low visible light reflectivity and haze.

It can be seen from the cross-sectional diagram of Example 4 (FIG. 3) that the overcoat layer completely filled the uneven sites on the surface of the low-emissivity layer. The overcoat layer and the low-emissivity layer formed a tight bond. Moreover, the overcoat layer had a smooth, flat and compact surface.

Although the specific embodiments of the present disclosure have been described above, it should be understood by those skilled in the art that this is by way of example only and the protection scope of the present disclosure is defined by the appended claims. Those skilled in the art may make various changes or modifications to these embodiments without departing from the principle and essence of the present disclosure, but these changes and modifications all fall within the protection scope of the present disclosure.

1. A glass stacking, comprising:
a glass substrate,
a low-emissivity layer, and
an overcoat layer,
wherein
the low-emissivity layer is between the glass substrate and the overcoat layer,
the low-emissivity layer is formed by chemical vapor deposition,
the overcoat layer is formed by a coating layer containing a wet coating,
the wet coating comprises a silica sol and/or a water glass solution.

2. The glass stacking according to claim 1, wherein the particle sizes of silica colloidal particles in the silica sol are 30 nm or less.

3. The glass stacking according to claim 1, wherein the particle sizes of silica colloidal particles in the silica sol are 20 nm or less.

4. The glass stacking according to claim 1, wherein the water glass solution comprises any one of a sodium water glass solution, a lithium water glass solution, a potassium water glass solution or any combination thereof.

5. The glass stacking according to claim 1, wherein the water glass solution has a water glass modulus of 2-4.

6. The glass stacking according to claim 1, wherein a solvent of the wet coating comprises water, alcohol, or a water-alcohol mixture.

7. The glass stacking according to claim 6, wherein the alcohol comprises ethanol and/or isopropanol.

8. The glass stacking according to claim 1, wherein the overcoat layer has a thickness of 90 nm-120 nm.

9. The glass stacking according to claim 1, wherein
the glass stacking has a visible light reflectivity of 2% or less; and/or
the glass stacking has a haze of 2% or less.

10. A process for preparing the glass stacking according to claim 1, comprising:
providing a glass substrate having a low-emissivity layer formed by chemical vapor deposition thereon, or providing a glass substrate and forming a low-emissivity layer by chemical vapor deposition on the glass substrate;
applying a wet coating on the low-emissivity layer to form a coating layer containing the wet coating on the surface of the low-emissivity layer;
drying the coating layer containing the wet coating, and curing the coating layer.

11. The process according to claim 10, wherein a manner of applying the wet coating comprises slot die.

12. A window assembly comprising the glass stacking according to claim 1.

13. The window assembly according to claim 12, wherein the window assembly comprises a door, a window, a curtain wall, a vehicle window glass, an airplane glass or a ship glass.
